(19) United States
(12) Patent Application Publication
(10) Pub. No.: US 2008/0088152 A1
(43) Pub. Date: Apr. 17, 2008

(54) Motor Vehicle Door With Split Side Window

(75) Inventor: Dalibor Rietdijk, Wetzlar (DE)

Correspondence Address: CHRISTIE, PARKER & HALE, LLP, PO BOX 7068, PASADENA, CA, 91109-7068, US

(73) Assignee: BROSE FAHRZEUGTEILE GMBH & CO. KG, COBURG, Coburg (DE)

(21) Appl. No.: 11/579,514

(22) PCT Filed: Apr. 22, 2005
(86) PCT No.: PCT/DE05/00769

§ 371 Date: Nov. 2, 2006

(30) Foreign Application Priority Data
May 3, 2004 (DE) 20 2004 007 054.5

(51) Int. Cl. B60J 1/08

(52) U.S. Cl. 296/146.2

(57) ABSTRACT

The invention relates to a motor vehicle door with a side window, wherein a window winder being associated with the side window, by means of which the side window is able to be lowered in the door body. The side window is of split configuration, wherein a separate window winder is associated with each window part, by means of which the respective window part may be completely lowered in the door body. In the closed state the window parts are held in contact with one another by the force of a spring.

### CROSS-REFERENCE TO A RELATED APPLICATION

This application is a National Phase Patent Application of International Patent Application Number PCT/DE2005/000769, filed on Apr. 22, 2005, which claims priority of German Patent Application Number 20 2004 007 054.5, filed on May 03, 2004.

### BACKGROUND

The invention relates to a motor vehicle door with a side window.

A motor vehicle door with a side window which may be raised and lowered and a front, fixed side window, is known from EP 1 201 862 A1. A cable window winder is arranged in the door body, by means of which the side window may be completely lowered into the door body. No window winder is associated with the front window part, so that said window part may not be lowered.

In such a window winder system, the window is only able to be completely lowered when the door body has a minimum size. Even with sports cars or convertibles, the door bodies are, however, often small, so that the window is not able to be completely lowered.

Doors are also known in which the window region is releasably attached to the door body and, if required, able to be removed manually and carried in the vehicle. This, however, requires manipulation and carrying the window parts restricts the available luggage space.

### SUMMARY

The object of the present invention is to develop a motor vehicle door, such that without additional manual handling, the side window is able to be completely lowered.

It is provided according to the invention that the window is of split configuration, that a separate window winder is associated with each window part, by means of which the respective window part may be completely lowered in the door body, and that, in the closed state, the window parts are held in contact with one another by the force of a spring. The window is preferably split into two parts, the split being created by a substantially horizontally extending line.

According to a preferred embodiment of the invention, window winders comprising slide and/or guide rails are used. The window winder associated with the lower window part, cooperates with the lower edge of this window, the winder cooperating with the upper window grips said upper window on the outer regions of the window lower edge and/or in a side region, which is enclosed by a window guide located above the door body. The guide rails and/or tracks of the window winder are designed, therefore, such that the window parts are lowered into the door body through a single slot arranged on the upper edge of the door body and are located parallel and adjacent to one another in the door body itself.

In an embodiment of the invention, firstly the lower window part is lowered and completely moved into the door body. Subsequently, the window winder associated with the upper window part is activated, which then moves this window into the door body. The reverse sequence is carried out to close the window region.

Firstly, the upper window is moved in this case into its end position, and then the lower window part, until the upper edge thereof comes into contact with the lower edge of the upper window.

In a preferred embodiment of the invention, the upper window part is received on the outer edges in window holders. For moving the window holders, drivable control cables are tensioned along the guide rails which act via driving units on the window holders and which, in turn, are mounted in guide rails.

By means of each compression spring associated with the front and rear combined driving unit-window holder, the upper window part is held relative to the driving units coupled to the cables in a lowermost position. Counter to this spring force of the spring arranged in the front and rear combined driving unit-window holder, the upper window part may be pressed further upwards by a predetermined distance. The spring force thus determines the sealing of the impact region between the edges of the upper and lower window part and, after switching off the window winder drives, the window parts remain sealingly in contact with one another, even with a possible yielding of the transmission elements.

With appropriate dimensioning of the path over which the window holder, next to the upper window part, may be moved counter to the spring force, relative to the driving unit coupled to the drive cable, the upper window part may be moved a small distance upwards by means of the drive of the lower window part. This results, on the one hand, in the secure sealing of the two window parts and, on the other hand, when closing a frameless door, the upper edge of the upper window part being able to be introduced into a sealing strip attached to the roof of the vehicle. Only the drive of the lower window part has to be controlled in this case and also for opening the door (lowering the window for releasing the seal—short stroke).

The window split according to the invention allows the complete lowering of a window region which is large compared to the door body. When the door bodies are cut away deeply downwards, such as for example with roadsters, no awkward window parts remain above the door body. Additional manual handling is also dispensed with, so that when using motor-driven window winders, comfortable operation results. By means of the spring elements between the window holders for the upper window part and the driving units, it is further possible to move the upper window part higher out of the door body than the arrangement of the deflection pulleys for the control cables allows. Thus the upper edge of the door body may be pulled a considerable distance downwards—the upper window part is only moved into the required end position by the lower window part during closing.

A further advantageous possibility in the application of the invention is created when the upper window part is introduced into the door body, the lower window part, however, still remaining stationary. The lower window part now functions as a splash guard.

### BRIEF DESCRIPTION OF THE DRAWINGS

Furthermore, the description of embodiments of the invention is made with reference to the figures, in which:

FIG. 1 shows a vehicle door with two window parts in the closed state.

FIG. 2 shows a vehicle door with two window parts in the opened state.

FIGS. 3-5 show the coupling of the window winder to the window parts.

FIGS. 6-8 show the arrangement of the driving unit, window holder and cable deflection pulley.

### DETAILED DESCRIPTION

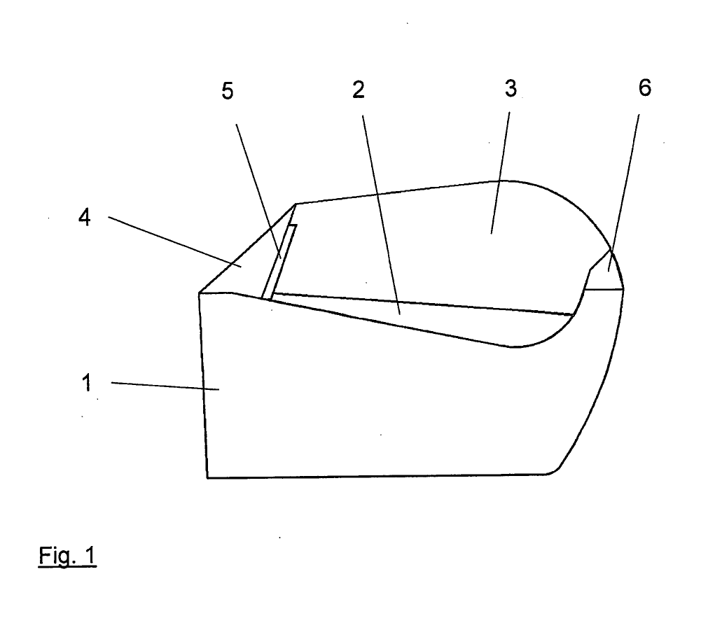

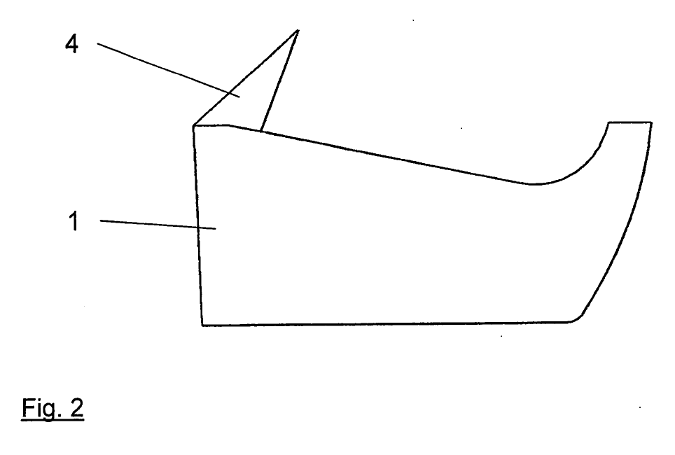

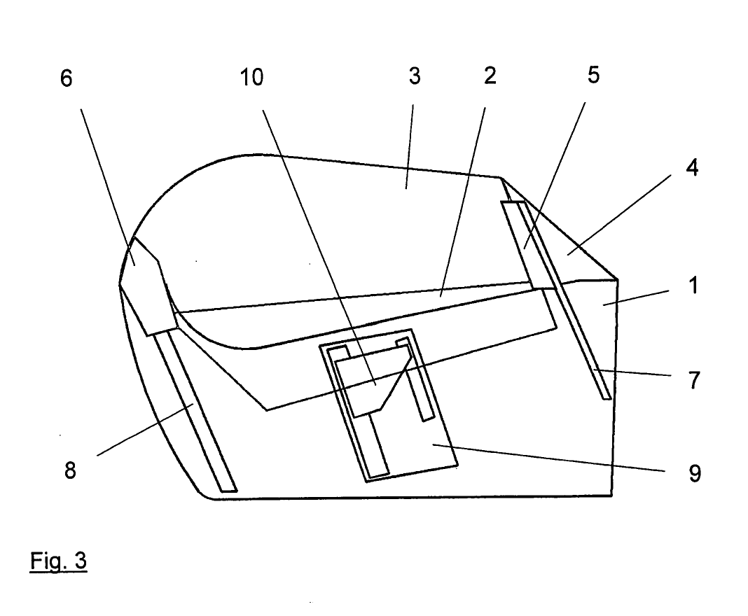

The vehicle door according to FIGS. 1 and 2—the door is shown in an external view—consists of a door body 1 and a window region arranged thereover, consisting of a lower and an upper window part 2, 3. In the direction of travel, upstream of the window region, a mirror triangle 4 is located above the door body. Two window holders 5, 6 are associated with the upper window part 3, which bear the upper window part 3 on the front edge thereof and/or in the rear region on the lower edge thereof (FIG. 3-5).

FIGS. 3-5 show the window winder arrangement for the two window parts 2, 3 from the vehicle interior. The window holders 5, 6 are displaceably coupled via driving units not shown in FIGS. 3-5 to a guide rail 7, 8 located in the front region of the door body and a guide rail located in the rear region of the door body and thus form the window winder for the upper window part 3. The rear window holder 6, in particular, projects over the upper edge of the door body 1 and is adapted in its form to the design of the vehicle door (FIG. 1).

FIG. 2 shows the vehicle door according to FIG. 1 in the opened state. As is shown in more detail below, firstly the lower and then the upper window part 2, 3 is lowered and moved into the door body 1. The region above the door body 1 is now windowless.

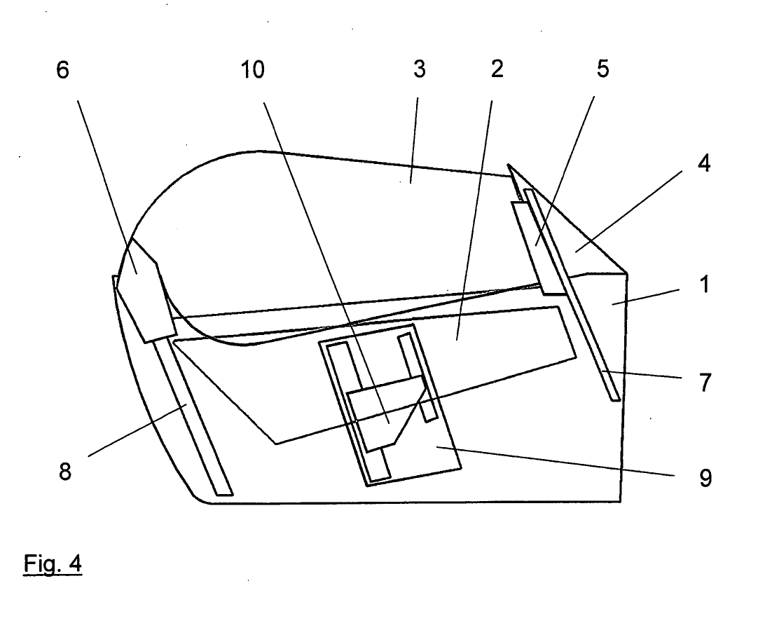

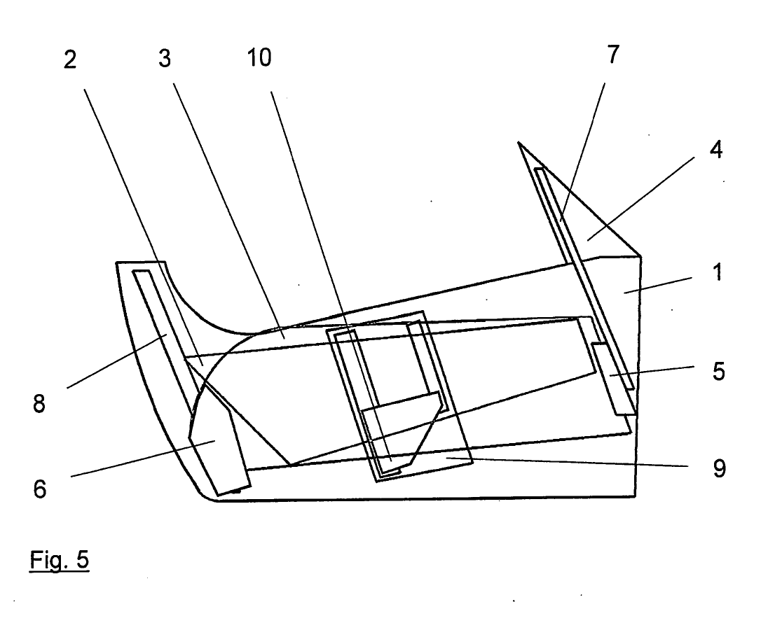

The lower window part 2 is received on its lower edge approximately centrally by a window holder 10, which is attached to a path-controlled window winder 9. The guideways of this window winder 9 are designed such that the lower window part 2, according to the conditions and the spatial relations, is moved into and out of the door body 1. In FIG. 3 the lower window part 2 is completely extended, in FIG. 4 a portion is retracted into the door body 1, in FIG. 5 the lower window part 2 is lowered completely in the door body 1 by the window winder 9.

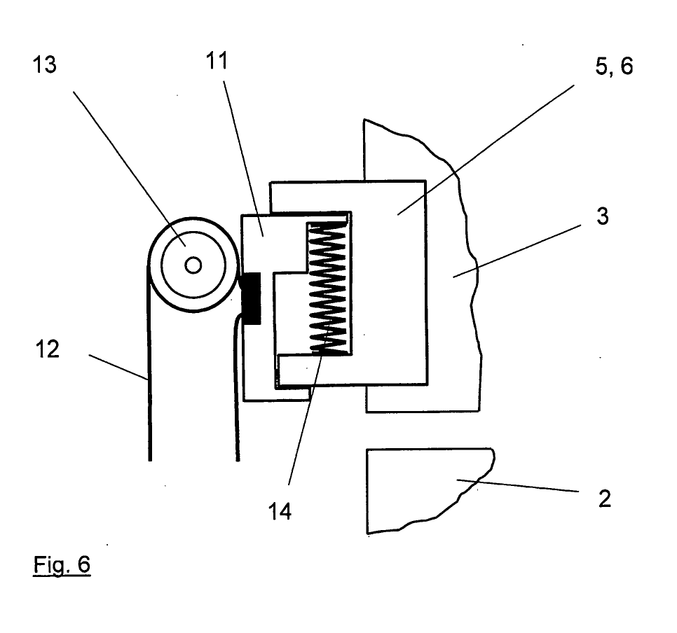

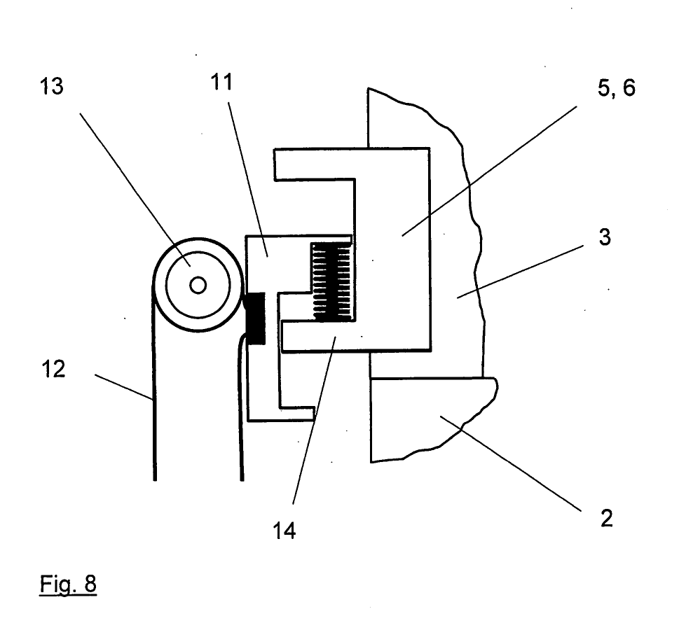

The driving units 11 cooperating with the window holders 5, 6 for the upper window part 3 may be moved via driven control cables 12 (not shown in FIGS. 3-5) along the slide rails 7, 8. When the lower window part 2 is lowered, the upper window part 3 follows said lower window part a certain distance, due to the spring forces between the driving units 11 and the window holders 5, 6 (FIGS. 6-8)—it is therefore lowered from the fully extended position according to FIG. 3 into the end position according to FIG. 4, defined by the control cable system 12, 13. By controlling the drive associated with the window winder 9, the upper window part 3 may now be fully retracted into the door body 1. The slide rails 7, 8 of the window winder of the upper window part 3 are designed according to the required inward and outward movement.

Closing the window is carried out by proceeding from the completely windowless situation according to FIG. 5. Firstly, by controlling the corresponding drive, the upper window part 3 is moved into the end position according to FIG. 4 defined by the control cable system 12, 13 (FIGS. 6-8). The lower window part 2 is now moved upwards and thus the upper edge thereof is brought into contact with the lower edge of the upper window part 3. Counter to the force of the springs between the window holders 5, 6 and the driving units 11 (FIGS. 6-8), the upper window part 3 is now pressed by the drive of the lower window part 2 into the upper end position. In this end position, therefore, the separating point between the two window parts 2, 3 is sealed by the force of the springs 14.

FIGS. 6-8 show the arrangement and the cooperation of the springs 14 between the driving unit 11 and the window holders 5, 6. The driving unit 11 for the upper window part 5, 6 is coupled to a control cable 12 guided around a cable pulley 13 and may be moved via a drive, not shown, until in the end position defined by the position of the cable pulley 13 in the door body. This end position according to FIG. 6 corresponds to the position of the upper window part 3 in FIG. 4—the lower window part 2 has no contact with the upper window part 2. A compression spring 14 arranged between the window holder 5, 6 for the upper window part 3 and the driving unit 11 coupled to the control cable 12, holds the window holder 5, 6 relative to the driving unit 11 in its lowermost position.

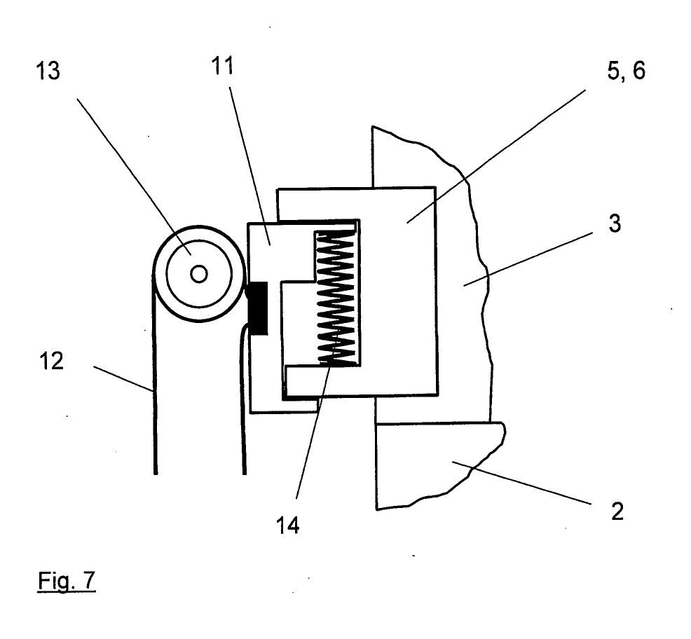

FIG. 7 shows the situation of the driving unit 11, the compression spring 14 and the window holder 5, 6 when the lower window part 2 is brought into contact with the lower edge of the upper window part 3. A further upward movement of the lower window part 2, therefore, causes the upper window part 3 to be lifted counter to the force of the compression spring 14, the window holder 5, 6 being therefore lifted from the driving unit 11. The same effect is produced by lowering the lower window part 2—by means of the compression spring 14 the window holder 5, 6 again comes into contact with the driving unit 11—the further lowering process then results by starting off the driving unit 11 via the control cable 12.

It is not shown that the driving unit 11 of the upper window part 3 may be designed to be pulled a considerable distance downwards, and thus serves as centering for the lower window part 2. By means of a fork-shaped configuration of the lower end of the driving unit 11 and the end oriented towards the lower window part 2, the lower window part 2 approaching the lower edge of the upper window part 3 is oriented and thus precisely guided into the contact position provided.

1-11. (canceled)

12. A motor vehicle door comprising a side window having a split configuration to provide a plurality of window parts, a plurality of window winders being associated with the side window and configured to lower the side window in a door body, wherein a separate window winder is associated with each window part, wherein each window winder is configured to lower the associated window part in the door body, and wherein in a closed state, the window parts are held in contact with one another by the force of a spring.

13. The motor vehicle door of claim 12, wherein the side window is split into an upper window part and a lower window part by a substantially horizontally extending separating region.

14. The motor vehicle door of claim 12 or 13, wherein at least one window winder associated with a window part comprises guide rails.

15. The motor vehicle door of claim 12, wherein a drive motor is associated with at least one window winder.

16. The motor vehicle door of claim 13, wherein at least one of the window winders is coupled to a lower edge of the lower window part.

17. The motor vehicle door of claim 13, wherein at least one of the window winders is coupled to the upper window part on a lateral edge region of the upper window part.

18. The motor vehicle door of claim 13, wherein at least one of the window winders is coupled to the upper window part on a lower edge in the edge region thereof.

19. The motor vehicle door of claim 12, wherein the upper window part is received in a window holder, and wherein the window holder is movable relative to a driving unit of the window winder and the spring holds the window holder relative to the driving unit in a lowermost position.

20. The motor vehicle door of claim 19, wherein the spring is configured as a compression spring.

21. The motor vehicle door of claim 19, wherein the driving unit is coupled to a drivable control cable of a control cable system.

22. The motor vehicle door of claim 19, wherein the driving unit has centering for the lower window part.
